(19) United States
(12) Patent Application Publication
(10) Pub. No.: US 2022/0099121 A1
(43) Pub. Date: Mar. 31, 2022

(54) PANEL ASSEMBLY AND AFTERTREATMENT ASSEMBLY INCLUDING PANEL ASSEMBLY

(71) Applicant: Caterpillar Inc., Peoria, IL (US)

(72) Inventors: Samuel S. Kumar, Dunlap, IL (US); Daniel Richard Barb, East Peoria, IL (US); Andrew Michael Denis, Normal, IL (US)

(73) Assignee: Caterpillar Inc., Peoria, IL (US)

(21) Appl. No.: 17/032,194

(22) Filed: Sep. 25, 2020

(51) Int. Cl. F16B 5/08; F16B 5/00

(52) U.S. Cl. CPC F16B 5/08; F16B 5/0036

(57) ABSTRACT

A panel assembly includes a panel member having a mounting side and at least one elongated member. The at least one elongated member includes a mounting edge, a second edge opposite the mounting edge of the at least one elongated member, and a plurality of first spaced apart openings. The panel assembly further includes at least one elongated intersecting member. The at least one elongated intersecting member includes a mounting edge, a second edge opposite the mounting edge of the at least one elongated intersecting member, and a plurality of second spaced apart openings. Further, one of the at least one elongated member and the at least one elongated intersecting member includes at least one slot, the at least one elongated member and the at least one elongated intersecting member intersecting at the at least one slot.

### TECHNICAL FIELD

The present disclosure relates to a panel assembly, and more particularly, an aftertreatment assembly including the panel assembly.

### BACKGROUND

An aftertreatment system is associated with an engine, such as an internal combustion engine, to reduce and convert particulate matter that may be present in exhaust gases exiting the engine. Some large aftertreatment systems include a service door that allows access to one or more components of the aftertreatment system during servicing/maintenance of the aftertreatment system. The service door is secured to a frame member of the aftertreatment system. Conventional service doors are heavy and lack strength and endurance. Further, conventional service doors are often expensive, complex to manufacture, and/or include a complicated design.

Moreover, the exhaust gases flowing through the aftertreatment system may cause exhaust gas pressure pulsations which may vibrate one or more components of the aftertreatment system. Such vibrations may be transferred to the service door and may cause cracking and failure of the service door. In order to prevent or minimize damage to the service door subjected to the exhaust gas pressure pulsations, it may be desirable for the service door to have natural frequencies outside the range of the pulsations.

U.S. Pat. No. 4,294,330 describes a muffler for a pneumatic impact device operating at a frequency below or about 60 Hertz. The muffler includes an elastomeric housing adapted to receive and discharge exhaust gas. Further, the elastomeric housing is divided into an admission chamber and a series of muffler chambers. An inlet conduit is communicating with the admission chamber and each muffler chamber. An exhaust conduit is communicating with each muffler chamber as well as with a tail pipe outside the elastomeric housing. A Helmholtz resonator is communicating with the admission chamber.

### SUMMARY OF THE DISCLOSURE

In an aspect of the present disclosure, a panel assembly is provided. The panel assembly includes a panel member including a mounting side. The panel assembly also includes at least one elongated member. The at least one elongated member includes a mounting edge secured to the mounting side of the panel member. The at least one elongated member also includes a second edge opposite the mounting edge of the at least one elongated member and distal to the panel member. The at least one elongated member further includes a plurality of first spaced apart openings proximate to the mounting edge of the at least one elongated member. The panel assembly further includes at least one elongated intersecting member. The at least one elongated intersecting member includes a mounting edge secured to the mounting side of the panel member. The at least one elongated intersecting member also includes a second edge opposite the mounting edge of the at least one elongated intersecting member and distal to the panel member. The at least one elongated intersecting member further includes a plurality of second spaced apart openings proximate to the mounting edge of the at least one elongated intersecting member. Further, one of the at least one elongated member and the at least one elongated intersecting member includes at least one slot, the at least one elongated member and the at least one elongated intersecting member intersecting at the at least one slot.

In another aspect of the present disclosure, an aftertreatment assembly is provided. The aftertreatment assembly includes an aftertreatment system including a frame member. The aftertreatment assembly also includes a panel assembly secured to the frame member of the aftertreatment system. The panel assembly includes a panel member including a mounting side. The panel assembly also includes at least one elongated member. The at least one elongated member includes a mounting edge secured to the mounting side of the panel member. The at least one elongated member also includes a second edge opposite the mounting edge of the at least one elongated member and distal to the panel member. The at least one elongated member further includes a plurality of first spaced apart openings proximate to the mounting edge of the at least one elongated member. The panel assembly further includes at least one elongated intersecting member. The at least one elongated intersecting member includes a mounting edge secured to the mounting side of the panel member. The at least one elongated intersecting member also includes a second edge opposite the mounting edge of the at least one elongated intersecting member and distal to the panel member. The at least one elongated intersecting member further includes a plurality of second spaced apart openings proximate to the mounting edge of the at least one elongated intersecting member. Further, one of the at least one elongated member and the at least one elongated intersecting member includes at least one slot, the at least one elongated member and the at least one elongated intersecting member intersecting at the at least one slot.

In yet another aspect of the present disclosure, a method of assembling a panel assembly is provided. The method includes providing a panel member including a mounting side. The method also includes securing at least one elongated member to the panel member at the mounting side. The at least one elongated member includes a mounting edge secured to the panel member, a second edge opposite the mounting edge of the at least one elongated member and distal to the panel member, and a plurality of first spaced apart openings proximate to the mounting edge of the at least one elongated member. The method further includes providing at least one elongated intersecting member. The at least one elongated intersecting member including a mounting edge, a second edge opposite the mounting edge of the at least one elongated intersecting member and distal to the panel member, and a plurality of second spaced apart openings proximate to the mounting edge of the at least one elongated intersecting member. Further, one of the at least one elongated member and the at least one elongated intersecting member includes at least one slot. The method includes intersecting the at least one elongated member with the at least one elongated intersecting member at the at least one slot. The method also includes securing the at least one elongated intersecting member to the panel member at the mounting side and the at least one elongated member at an intersection of the at least one elongated member and the at least one elongated intersecting member.

### BRIEF DESCRIPTION OF DRAWINGS

FIG. 1 illustrates a perspective view of an aftertreatment assembly having an aftertreatment system and a panel assembly, in accordance with the present disclosure;

FIG. 2 illustrates a perspective view of the panel assembly of FIG. 1, in accordance with the present disclosure;

FIG. 3 illustrates an elongated member of the panel assembly of FIG. 2;

FIG. 4 illustrates an elongated intersecting member of the panel assembly of FIG. 2;

FIG. 5 illustrates a top view of a portion of the panel assembly of FIG. 2;

FIG. 6 illustrates an exploded view of the panel assembly of FIG. 2;

FIG. 7 illustrates a perspective view of a portion of the panel assembly of FIG. 2;

FIGS. 8 and 9 illustrate another design of a panel assembly associated with the aftertreatment assembly of FIG. 1, in accordance with the present disclosure; and

FIG. 10 illustrates a flowchart for a method of assembling the panel assembly.

### DETAILED DESCRIPTION

Wherever possible, the same reference numbers will be used throughout the drawings to refer to same or like parts.

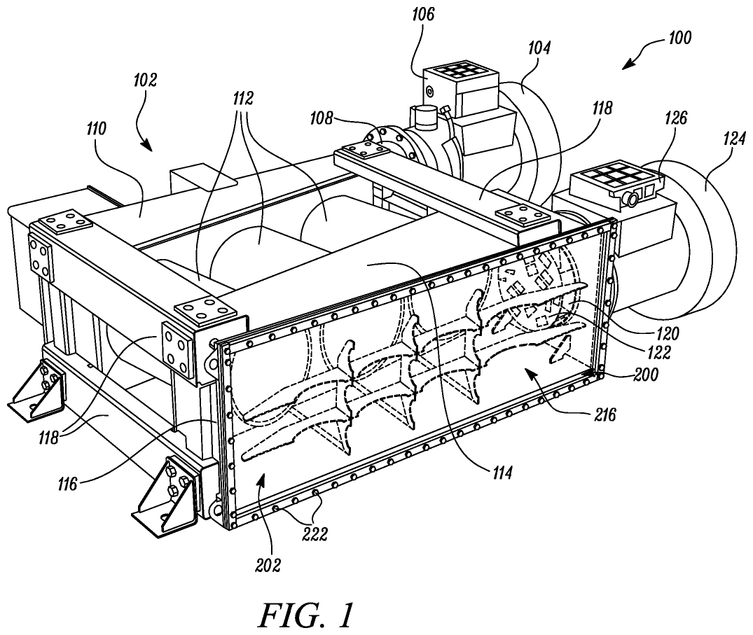

FIG. 1 illustrates an exemplary aftertreatment assembly 100. The aftertreatment assembly 100 is positioned at an exhaust side (not shown) of an engine (not shown), such as an internal combustion engine. In an example, the engine may include a high-speed diesel engine, such as a marine engine. The aftertreatment assembly 100 may be associated with a mobile machine, such as a construction machine or a marine ship, a stationary machine, such as a generator, and the like, as per application requirements. The aftertreatment assembly 100 includes an aftertreatment system 102. The aftertreatment system 102 includes an inlet tube 104 that is in fluid communication with the engine for receiving exhaust gases exiting the engine. The exhaust gases may contain emission compounds, such as nitrogen oxides (NOx), carbon monoxide (CO), unburned hydrocarbons, particulate matter, and other such combustion products in a non-uniform proportion.

Further, an inlet wiring control box 106 is positioned at an outside of the inlet tube 104. In some examples, the inlet wiring control box 106 may include sensors to detect one or more parameters of the exhaust gases exiting the aftertreatment system 102. The aftertreatment system 102 includes a first mixer tube 108 that is in fluid communication with the inlet tube 104. The first mixer tube 108 allows uniform mixing of the exhaust gases. The first mixer tube 108 may include one or more mixers (not shown) and/or baffles (not shown) for mixing of the exhaust gases. Further, the homogenous exhaust gases are directed towards an inlet chamber 110 of the aftertreatment system 102. The aftertreatment system 102 also includes a number of Selective Catalytic Reduction (SCR) modules 112. The exhaust gases from the inlet chamber 110 are directed towards the SCR modules 112. In other configurations, the aftertreatment system 102 may include components (not shown), such as a diesel oxidation catalyst module, one or more filters such as a diesel particulate filter, and the like, without any limitations.

Further, the SCR modules 112 are in fluid communication with an outlet chamber 114 that receives the exhaust gases from the SCR modules 112. The aftertreatment system 102 includes a frame member 116. More particularly, the frame member 116 forms a portion of the outlet chamber 114. The frame member 116 is substantially rectangular in shape. In some examples, the frame member 116 may include a threaded metal bar. As illustrated, the inlet chamber 110 is secured to the outlet chamber 114 by a number of support structures 118. Moreover, the aftertreatment system 102 includes a second mixer tube 120 and a baffle 122 that is connected at an inlet side of the second mixer tube 120. The baffle 122 allows homogeneous mixing of the exhaust gases. Further, the second mixer tube 120 may include one or more mixers (not shown) and/or baffles (not shown) disposed therein for promoting mixing of the exhaust gases. The exhaust gases exit the aftertreatment system 102 via an outlet tube 124. Moreover, an outlet wiring control box 126 is positioned at an outside of the outlet tube 124. The outlet wiring control box 126 may include sensors to detect one or more parameters of the exhaust gases exiting the aftertreatment system 102.

The aftertreatment system 102 also includes a panel assembly 200 secured to the aftertreatment system 102. More particularly, the panel assembly 200 is secured to the frame member 116 of the aftertreatment system 102. The panel assembly 200 allows access to the outlet chamber 114 and to other components of the aftertreatment system 102, such as the SCR modules 112, the baffle 122, the second mixer tube 120, and the like.

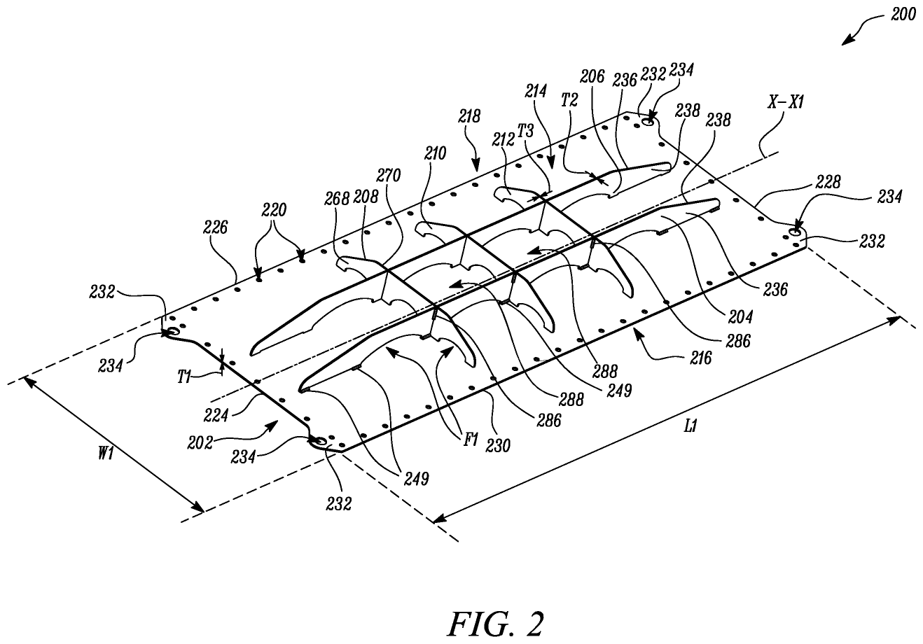

FIG. 2 illustrates a perspective view of the panel assembly 200. The panel assembly 200 defines a longitudinal axis “X-X1”. In an example, the panel assembly 200 is made from stainless steel. In other examples, the panel assembly 200 may be made from other metals or alloys, without any limitations. The panel assembly 200 includes a panel member 202. The panel assembly 200 also includes elongated members 204, 206 and elongated intersecting members 208, 210, 212 that will be explained later in this section.

Further, the panel member 202 is generally rectangular in shape. The panel member 202 includes a panel length “L1”, a panel width “W1”, and a panel thickness “T1”. The panel length “L1” may approximately lie in a range of 1200 millimeter (mm) to 1600 mm. The panel width “W1” may approximately lie in a range of 400 mm to 800 mm. Moreover, the panel thickness “T1” may approximately lie in a range of 2 mm to 6 mm. Hereinafter, the panel length “L1”, the panel width “W1”, and the panel thickness “T1” may be referred to as panel dimensions “L1”, “W1”, “T1”. The panel dimensions “L1”, “W1”, “T1” may vary according to variation in dimensions of one or more components of the aftertreatment assembly 100.

The panel member 202 includes a mounting side 214. When the panel assembly 200 is secured to the frame member 116 (see FIG. 1), the mounting side 214 faces the aftertreatment system 102 and may be referred to as the inside. Further, the panel member 202 includes an outside 216 that is opposite to the mounting side 214. The outside 216 faces away from the aftertreatment system 102. Further, the panel member 202 includes an outer periphery 218 and a number of mounting apertures 220 disposed proximate to the outer periphery 218. Each mounting aperture 220 aligns with a corresponding aperture (not shown) in the frame member 116 for receiving a mechanical fastener 222 (shown in FIG. 1) therethrough for removably securing the panel assembly 200 to the frame member 116. Thus, the panel assembly 200 is secured to the frame member 116 by the mechanical fasteners 222. The mechanical fasteners 222 are embodied as bolts herein. Alternatively, the mechanical fasteners 222 may include screws, pins, and the like. Further, a metal bar with threaded nuts (not shown) may be disposed adjacent to the panel member 202 that couples with the mechanical fasteners 222. Moreover, a gasket (not shown) is disposed between the panel member 202 and the frame member 116 for restricting leakage of exhaust gases.

Further, the panel member 202 includes a first side edge 224, a second side edge 226, a third side edge 228, and a fourth side edge 230. The panel member 202 includes one or more lifting eyes 232 extending from the outer periphery 218 of the panel member 202. The lifting eyes 232 are disposed proximate to corners of the outer periphery 218. More particularly, the panel member 202 includes the first pair of lifting eyes 232 extending from the first side edge 224 of the panel member 202 and the second pair of lifting eyes 232 extending from the third side edge 228 of the panel member 202. In other embodiments, the panel member 202 may include more than four or less than four lifting eyes 232. Each lifting eye 232 includes a through-hole 234. In an example, the lifting eyes 232 may be provided by cutting a sheet of metal using a material removal technique, such as using a laser. Alternatively, any other techniques known in the art may be used to provide the lifting eyes 232.

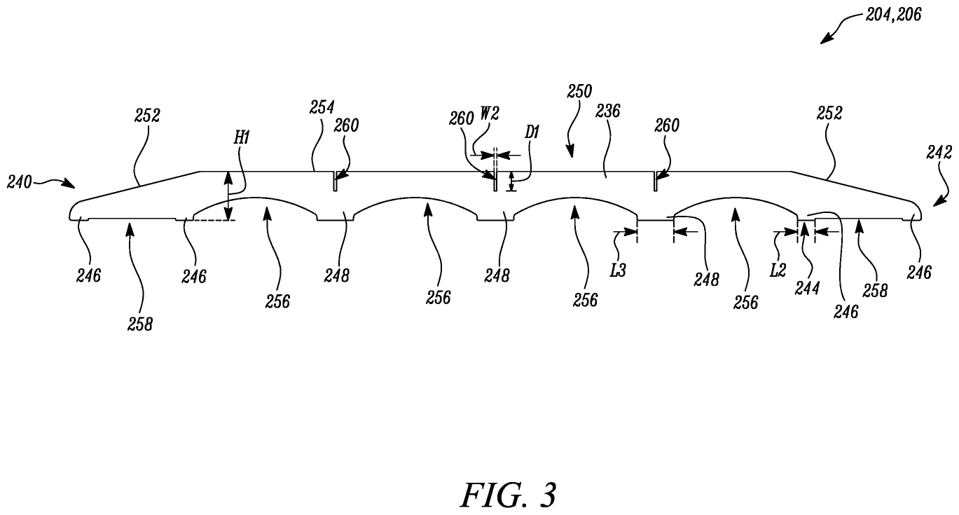

The panel assembly 200 also includes the one or more elongated members 204, 206. The elongated members 204, 206 may be mounted parallel to the longitudinal axis “X-X1” of the panel assembly 200. In the illustrated example, the panel assembly 200 includes two elongated members 204, 206. However, a total number of the elongated members 204, 206 may vary based on dimensions of the aftertreatment system 100, as per application requirements. The elongated members 204, 206 include a first thickness “T2”. The first thickness “T2” may approximately lie in a range of 2 mm to 6 mm. In an example, the first thickness “T2” may be equal to the panel thickness “T1”. In another example, the first thickness “T2” may be different from the panel thickness “T1”. The elongated members 204, 206 also include a first height “H1” (shown in FIG. 3). The first height “H1” may approximately lie in a range of 25 mm to 125 mm. It should be noted that the ranges for the first thickness “T2” and the first height “H1” provided herein are exemplary in nature and the ranges may vary as per application requirements.

The elongated members 204, 206 are secured to the panel member 202 at the mounting side 214. Each elongated member 204, 206 includes an outer surface 236 and an inner surface 238. The inner surface 238 of the elongated member 204 faces the inner surface 238 of the elongated member 206. Referring to FIG. 3, the one or more elongated members 204, 206 include a first end 240 and a second end 242. The one or more elongated members 204, 206 also include a mounting edge 244 secured to the mounting side 214 of the panel member 202 (see FIG. 2). More particularly, each of the one or more elongated members 204, 206 includes a number of spaced apart first base portions 246, 248 such that each first base portion 246, 248 is disposed adjacent to a first opening 256, 258. The first base portions 246 are disposed proximate to the first and second ends 240, 242. In the illustrated example, each elongated member 204, 206 includes four first base portions 246. Further, the first base portions 248 are centrally disposed. In the illustrated example, each elongated member 204, 206 includes three first base portions 248. The elongated members 204, 206 are secured to the panel member 202 at the number of first base portions 246, 248.

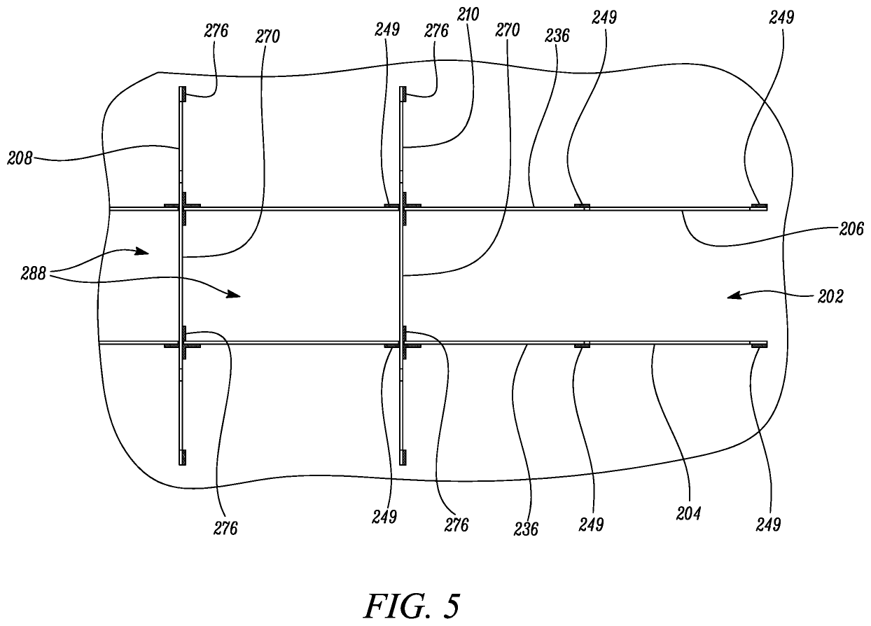

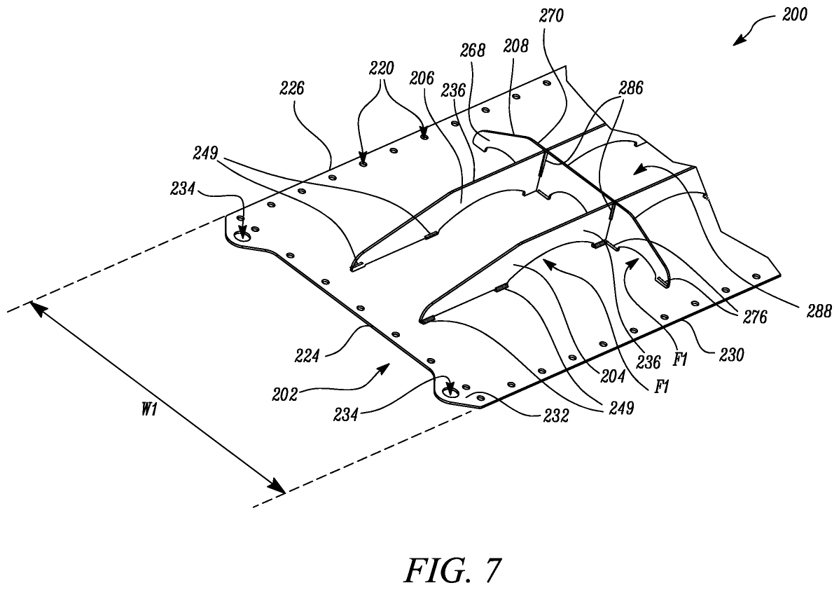

Each first base portion 246, 248 includes a first length “L2”, “L3” that approximately lies in a range of 10 mm to 40 mm. In the illustrated example, the first base portions 246 that are disposed proximate to the first and second ends 240, 242 include the first length “L2” that is lesser than the first length “L3” of the first base portions 248 that are centrally disposed. The elongated members 204, 206 are secured to the panel member 202 at the corresponding first base portions 246, 248 by welding. In this embodiment, the first base portions 246, 248 of the elongated members 204, 206 are secured to the panel member 202 at the outer surface 236 of the elongated members 204, 206 (as best illustrated in FIGS. 5 and 7). Further, the number of first base portions 246, 248 of the elongated members 204, 206 may be secured to the panel member 202 at the inner surface 238 of the elongated members 204, 206.

In the illustrated embodiment, the first base portions 246, 248 are welded to the panel member 202. The elongated member 204, 206 is secured to the panel member 202 by welding using 3 mm to 6 mm fillet welds as illustrated by weld marks 249 (shown in FIGS. 5 and 7). In another example, any other welding technique, such as spot welding or stitch welding, may be used to secure the elongated intersecting members 204, 206 to the panel member 202. The one or more elongated members 204, 206 also include a second edge 250 opposite the mounting edge 244 of the one or more elongated members 204, 206 and distal to the panel member 202. The second edge 250 includes a pair of taper surfaces 252 and a straight surface 254 extending between the pair of taper surfaces 252.

The one or more elongated members 204, 206 further include the number of first spaced apart openings 256, 258 proximate to the mounting edge 244 of the one or more elongated members 204, 206. Each of the first openings 256, 258 is disposed adjacent to the mounting edge 244 of the one or more elongated members 204, 206. In this embodiment, the elongated members 204, 206 include four first openings 256 that are centrally disposed and two first openings 258 that disposed proximate to the first and second ends 240, 242. It should be noted that each first opening 256 may have a different dimension, for example, a radius of each first opening 256 may be different, as per application requirements.

A total number of the first openings 256, 258 may vary depending on a length of the corresponding elongated members 204, 206. In the illustrated embodiment, a shape of the first openings 256 is different from a shape of the first openings 258. More particularly, the four first openings 256 are arch shaped and the two first openings 258 are rectangular shaped. Alternatively, the shape of the first openings 256 may be similar to the shape of the first openings 258. Further, in some embodiments, the first openings 256 may have a different shape, such as a rectangular shape, a square shape, and the like.

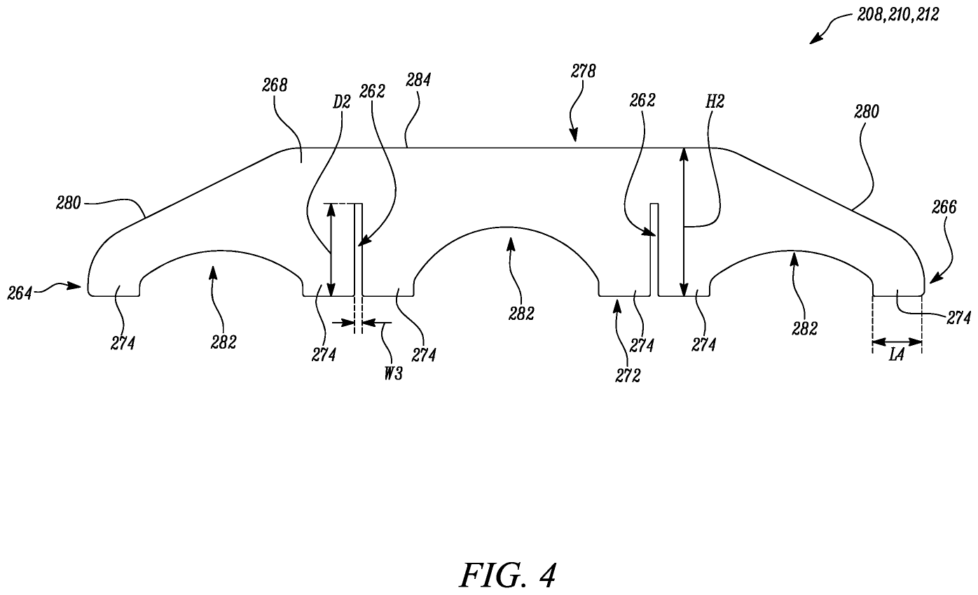

Moreover, the one or more elongated members 204, 206 or the one or more elongated intersecting members 208, 210, 212 include one or more slots 260, 262 (shown in FIG. 4). The one or more elongated members 204, 206 and the one or more elongated intersecting members 208, 210, 212 intersect at the one or more slots 260, 262. In the illustrated example, the one or more elongated members 204, 206 include the one or more first slots 260 and the one or more elongated intersecting members 208, 210, 212 include the one or more second slots 262. In some examples, the one or more elongated members 204, 206 may omit the first slots 260 and only the elongated intersecting members 208, 210, 212 may include the second slots 262. In other examples, the one or more elongated members 204, 206 may include the first slots 260 and the elongated intersecting members 208, 210, 212 may omit the second slots 262.

Further, the one or more first slots 260 are disposed proximate to the second edge 250 of the one or more elongated members 204, 206. The first slots 260 extend from the second edge 250 towards the mounting edge 244. Each first slot 260 is disposed between adjacent first openings 256. In the illustrated example, each elongated member 204, 206 includes three first slots 260. More particularly, a total number of the first slots 260 is equal to a total number of the elongated intersecting members 208, 210, 212. However, the total number of the first slots 260 may vary, as per application requirements. The three first slots 260 are equidistant to each other. The first slots 260 are rectangular in shape. Each first slot 260 includes a first depth “D1” and a first width “W2”. The first depth “D1” is lesser than the first height “H1” of the elongated members 204, 206. Further, each first slot 260 includes a tolerance stack up gap. The tolerance stack up that may approximately lie in a range between 0.3 mm and 1 mm

Referring to FIG. 4, the panel assembly 200 includes the one or more elongated intersecting members 208, 210, 212. The elongated intersecting members 208, 210, 212 are substantially perpendicular to the longitudinal axis “X-X1” (see FIG. 2) of the panel assembly 200. In the illustrated example, the panel assembly 200 includes three elongated intersecting members 208, 210, 212. However, the total number of the elongated intersecting members 208, 210, 212 may vary based on dimensions of the aftertreatment system 100, as per application requirements. Each elongated intersecting member 208, 210, 212 includes a second thickness “T3” (shown in FIG. 2). The second thickness “T3” may approximately lie in a range of 2 mm to 6 mm. In an example, the second thickness “T3” may be equal to the panel thickness “T1” (see FIG. 2) and the first thickness “T2” (see FIG. 2). In another example, the second thickness “T3” may be different from the panel thickness “T1” and the first thickness “T2”. Each elongated intersecting member 208, 210, 212 also includes a second height “H2”. The second height “H2” may approximately lie in a range of 25 mm to 125. In the illustrated example, the second height “H2” is approximately equal to the first height “H1” (see FIG. 3). Accordingly, the straight surface 254 of each elongated member 204, 206 is co-planar with the straight surface 284 of the elongated intersecting members 208, 210, 212. In another example, the second height “H2” may be lesser than or greater than the first height “H1”. It should be noted that the ranges for the second thickness “T3” and the second height “H2” provided herein are exemplary in nature and the ranges may vary as per application requirements.

The elongated intersecting members 208, 210, 212 are secured to the panel member 202 at the mounting side 214. Further, each elongated intersecting member 208, 210, 212 is secured to each elongated member 204, 206. Each of the one or more elongated intersecting members 208, 210, 212 includes a left surface 268 and a right surface 270. When assembled, the right surface 270 of the elongated intersecting member 208 faces the left surface 268 of the elongated intersecting member 210, whereas the right surface 270 of the elongated intersecting member 210 faces the left surface 268 of the elongated intersecting member 212.

Each elongated intersecting member 208, 210, 212 includes a first end 264 and a second end 266. The one or more elongated intersecting members 208, 210, 212 also include a mounting edge 272 secured to the mounting side 214 of the panel member 202 (see FIG. 2). More particularly, each of the one or more elongated intersecting members 208, 210, 212 includes a number of second base portions 274 such that each second base portions 274 is disposed adjacent to a second opening 282. In the illustrated example, each elongated intersecting member 208, 210, 212 includes six second base portions 274. The one or more elongated intersecting members 208, 210, 212 are secured to the panel member 202 at the number of second base portions 274. Each second base portion 274 includes a second length “L4” that lies in a range of 10 mm to 40 mm.

The one or more elongated members 204, 206 and the one or more elongated intersecting members 208, 210, 212 are secured to the panel member 202 by welding. As shown in FIG. 5, the elongated intersecting members 208, 210, 212 are secured to the panel member 202 at the corresponding second base portions 274 (see FIG. 4) by welding. In an example, the second base portions 274 of the elongated intersecting members 208, 210, 212 are secured to the panel member 202 at the right surface 270 of the elongated intersecting members 208, 210, 212. In another example, the number of second base portions 274 of the elongated intersecting members 208, 210, 212 may be secured to the panel member 202 at the left surface 268 of the elongated intersecting members 208, 210, 212.

In the illustrated embodiment, the second base portions 274 of the one of the one or more elongated intersecting members 208, 210, 212 are welded to the panel member 202. The elongated intersecting member 208, 210, 212 is secured to the panel member 202 by welding using 3 mm to 6 mm fillet welds as illustrated by weld marks 276. In another example, any other welding technique, such as spot welding or stitch welding, may be used to secure the elongated intersecting members 208, 210, 212 to the panel member 202.

Referring now to FIG. 4, the one or more elongated intersecting members 208, 210, 212 also include a second edge 278 opposite the mounting edge 272 of the one or more elongated intersecting members 208, 210, 212 and distal to the panel member 202. The second edge 278 includes a pair of taper surfaces 280 and a straight surface 284 extending between the pair of taper surfaces 280.

The one or more elongated intersecting members 208, 210, 212 include the number of second spaced apart openings 282 proximate to the mounting edge 272 of the one or more elongated intersecting members 208, 210, 212. Each of the first openings 256, 258 and the second openings 282 includes an air flow path “F1”. Further, each of the second openings 282 is disposed adjacent to the mounting edge 272 of the one or more elongated intersecting members 208, 210, 212. In this embodiment, the elongated intersecting members 208, 210, 212 include three second openings 282. A total number of the second openings 282 may vary depending on a length of the corresponding elongated intersecting members 208, 210, 212. In the illustrated example, the shape of the first openings 256 (see FIG. 3) is same as a shape of the second openings 282. Each of the number of first openings 256 and the number of second openings 282 is arch shaped. In other embodiments, the number of second openings 282 may have a different shape, such as a rectangular shape, a square shape, and the like. In other examples, the shape of the first openings 256 may be different from the shape of the second openings 282. It should be noted that each second opening 282 may have a different dimension, for example, a radius of each second opening 282 may be different, as per application requirements.

The one or more elongated intersecting members 208, 210, 212 include the one or more second slots 262 proximate to the mounting edge 272 of the one or more elongated intersecting members 208, 210, 212. In some examples, the elongated intersecting members 208, 210, 212 may omit the second slots 262, and only the elongated members 204, 206 may include the first slots 260. The one or more second slots 262 are disposed proximate to the mounting edge 272 of the one or more elongated intersecting members 208, 210, 212. The second slots 262 extend from the mounting edge 272 towards the second edge 278 of the elongated intersecting members 208, 210, 212. Further, each second slot 262 is disposed between adjacent second openings 282. In the illustrated example, the elongated intersecting members 208, 210, 212 include two second slots 262. More particularly, a total number of the second slots 262 is equal to the total number of the elongated members 204, 206. However, the total number of the second slots 262 may vary, as per application requirements.

The second slots 262 are rectangular in shape. Each second slot 262 includes a second depth “D2” and a second width “W3”. The second depth “D2” is lesser than the second height “H2” of the elongated intersecting members 208, 210, 212. In some embodiments, the first width “W2” (see FIG. 3) of the first slot 260 may be same as the second width “W3” of the second slot 262. In other embodiments, the first width “W2” may be different from the second width “W3”. Further, in some examples, the first depth “D1” (see FIG. 3) is lesser than the second depth “D2”. In some examples, a difference between the first depth “D1” and the second depth “D2” may approximately lie between 1 mm and 4 mm. Further, each second slot 262 includes a tolerance stack up gap. The tolerance stack up that may approximately lie in a range between 0.3 mm and 1 mm.

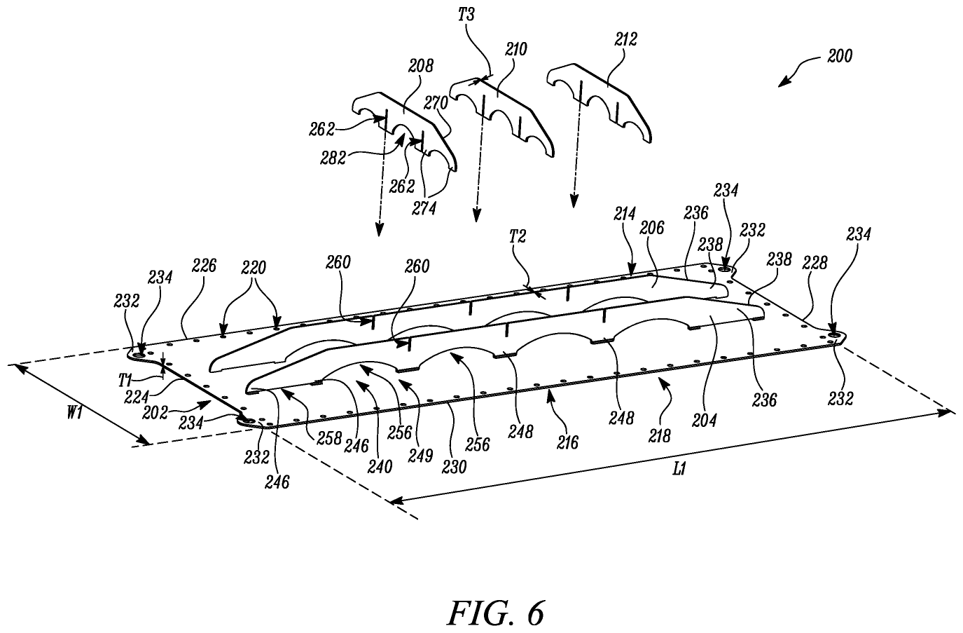

Referring to FIG. 6, the one or more second slots 262 of the one or more elongated intersecting members 208, 210, 212 intersect with the one or more first slots 260 of the one or more elongated members 204, 206. The first slots 260 in the elongated member 204 intersect with the corresponding second slots 262 in the elongated intersecting members 208, 210, 212 for securing the elongated intersecting members 208, 210, 212 to the elongated member 204. Further, the first slots 260 in the elongated member 206 also intersects with the corresponding second slots 262 in the elongated intersecting members 208, 210, 212 for securing the elongated intersecting member 208, 210, 212 to the elongated member 206.

Referring now to FIG. 7, the one or more elongated intersecting members 208, 210, 212 are secured to the one or more elongated members 204, 206 by welding. As illustrated, the outer surface 236 of the elongated member 204, 206 is welded to the left surface 268 of each elongated intersecting member 208, 210, 212 at the intersection of the slots 260, 262 (see FIGS. 3 and 4) as illustrated by weld marks 286. More particularly, the inner surface 238 of the elongated member 204, 206 is welded to the left surfaces 268 of each elongated intersecting member 208, 210, 212 at the intersection of the slots 260, 262. In an example, the elongated intersecting members 208, 210, 212 are secured to the elongated members 204, 206 using 3 mm to 6 mm fillet welds. The securing of the elongated intersecting member 208, 210, 212 to the panel member 202 and the elongated member 204, 206 divides the panel member 202 into a number of areas 288. More particularly, the elongated members 204, 206 and the elongated intersecting members 208, 210, 212 divide the panel member 202 into twelve areas 288.

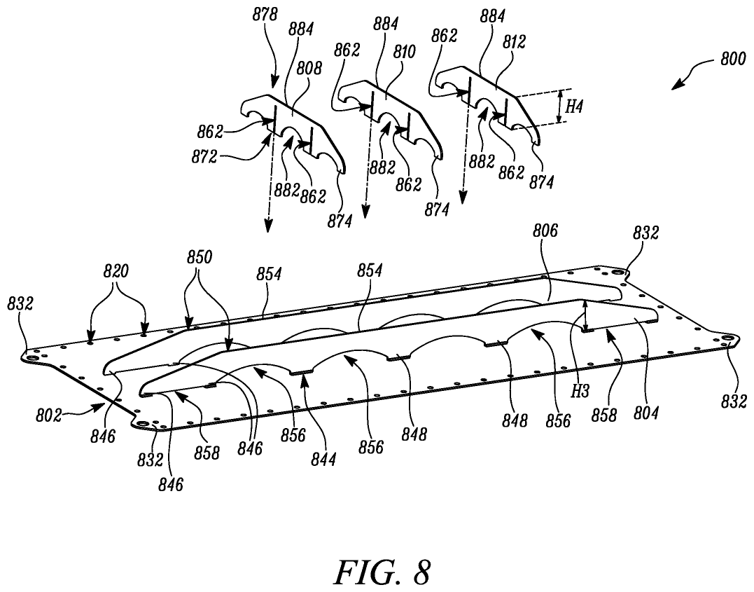

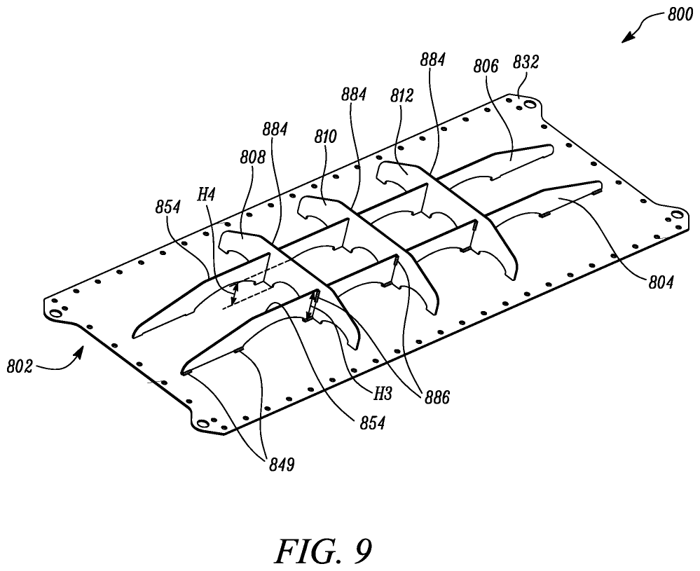

FIGS. 8 and 9 illustrate another embodiment of the present disclosure. As illustrated in FIG. 8, a panel assembly 800 is illustrated. The panel assembly 800 includes a panel member 802. The panel member 802 is similar to the panel member 202 of the panel assembly 200 described in relation to FIG. 2. As illustrated, the panel member 802 includes the mounting apertures 820 and the lifting eyes 832 similar to the mounting apertures 220 and the lifting eyes 232 explained in relation to FIG. 2.

The panel assembly 800 includes two elongated members 804, 806. The elongated members 804, 806 are similar to the elongated members 204, 206 of the panel assembly 200 described in relation to FIG. 3. Further, the elongated members 804, 806 include a first height “H3”. The elongated members 804, 806 include a mounting edge 844, a second edge 850, a number of first openings 856, 858, and a number of first base portions 846, 848 similar to the mounting edge 244, the second edge 250, the number of first openings 256, 258, and the number of first base portions 246, 248 described in relation to FIG. 3. It should be noted that in the illustrated embodiment, the elongated members 804, 806 do not include the first slots similar to the first slots 260 in the elongated members 204, 206 explained in relation to FIG. 3.

Further, the panel assembly 800 described herein includes three elongated intersecting members 808, 810, 812. The elongated intersecting members 808, 810, 812 are similar to the elongated intersecting members 208, 210, 212 of the panel assembly 200 described in relation to FIG. 4. Further, the elongated intersecting members 808, 810, 812 include a second height “H4”. In the illustrated embodiment, the second height “H4” is greater than the first height “H3”. Accordingly, a straight surface 854 of each elongated member 804, 806 is not co-planar with a straight surface 884 of the elongated intersecting members 808, 810, 812. More particularly, the straight surface 854 of each elongated member 804, 806 is spaced apart from the straight surface 884 of the elongated intersecting members 808, 810, 812. The elongated intersecting members 808, 810, 812 include a mounting edge 872, a second edge 878, a number of second openings 882, a number of second base portions 874, and a number of second slots 862 similar to the mounting edge 272, the second edge 278, the number of second openings 282, the number of second base portions 274, and the number of second slots 262 described in relation to FIG. 4. In this embodiment, the second slots 862 allow intersection of the elongated members 804, 806 with the elongated intersecting members 808, 810, 812.

Referring to FIG. 9, the elongated members 804, 806 are secured to the panel member 802 by welding as illustrated by weld marks 849. Further, the elongated intersecting members 808, 810, 812 are also secured to the panel member 802 by welding. Further, the elongated members 804, 806 are secured to the elongated intersecting members 808, 810, 812. More particularly, each of the second slots 862 (see FIG. 8) receives a portion of the elongated members 804, 806 for securing the elongated intersecting members 808, 810, 812 with the corresponding elongated members 804, 806. The elongated member 804 is secured to each of the elongated intersecting members 808, 810, 812 at a location where the corresponding second slots 862 intersect with the elongated member 804. Further, the elongated member 806 is secured to each of the elongated intersecting members 808, 810, 812 at a location where the corresponding second slots 862 intersect with the elongated member 806. The elongated members 804, 806 are secured to the elongated intersecting members 808, 810, 812 by welding as illustrated by weld marks 886. Further, details pertaining to various welding connections between the panel member 802, the elongated members 804, 806, and the elongated intersecting members 808, 810, 812 are similar to details pertaining to various welding connections between the panel member 202, the elongated member 204, 206, and the elongated intersecting members 208, 210, 212 of the panel assembly 200.

Further, design and details pertaining to arrangement of various parts of the panel assembly 800 are similar to design and details pertaining to arrangement of various parts of the panel assembly 200. However, dimensions of the panel member 802, the elongated members 804, 806, and the elongated intersecting members 808, 810, 812 may vary as per application requirements.

### INDUSTRIAL APPLICABILITY

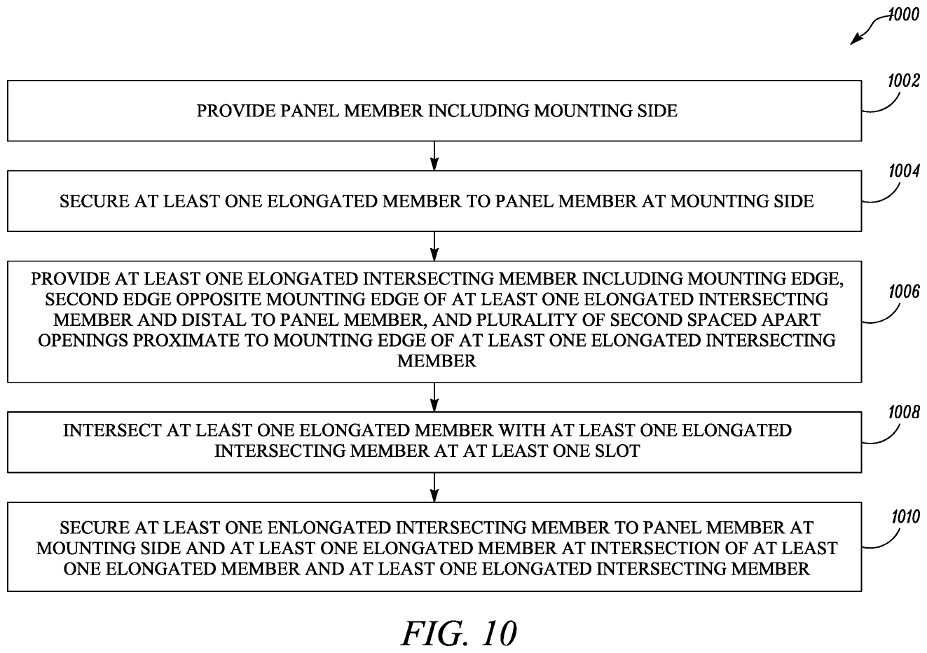

For explanatory purposes, this section will now be explained in relation to the panel assembly 200. However, it should be noted that the details provided in this section is equally applicable to the panel assembly 800, without any limitations. FIG. 10 illustrates a method 1000 for assembling the panel assembly 200. At step 1002, the panel member 202 including the mounting side 214 is provided.

At step 1004, the one or more elongated members 204, 206 are secured to the panel member 202 at the mounting side 214. The one or more elongated members 204, 206 include the mounting edge 272, the second edge 278 opposite the mounting edge 272 of the one or more elongated members 204, 206 and distal to the panel member 202, and the number of first spaced apart openings proximate to the mounting edge 272 of the one or more elongated members 204, 206. Further, the one or more elongated members 204, 206 are secured to the panel member 202 by welding.

At step 1006, the one or more elongated intersecting members 208, 210, 212 are provided. The one or more elongated intersecting members 208, 210, 212 include the mounting edge 272, the second edge 278 opposite the mounting edge 272 of the one or more elongated intersecting members 208, 210, 212 and distal to the panel member 202, and the number of second spaced apart openings 282 proximate to the mounting edge 272 of the one or more elongated intersecting members 208, 210, 212. Further, the one or more elongated members 204, 206 or the one or more elongated intersecting members 208, 210, 212 include the one or more slots 260, 262.

At step 1008, the one or more elongated intersecting members 208, 210, 212 intersect with the one or more elongated members 204, 206 at the one or more slots 260, 262. At step 1010, the one or more elongated intersecting members 208, 210, 212 are secured to the panel member 202 at the mounting side 214 and the one or more elongated members 204, 206 at the intersection of the one or more elongated members 204, 206 and the one or more elongated intersecting members 208, 210, 212. Further, the one or more elongated intersecting members 208, 210, 212 are secured to the panel member 202 and the one or more elongated members 204, 206 by welding.

The panel assembly 200 described herein is removably secured to the frame member 116 using the mechanical fasteners 222. Thus, the panel assembly 200 may be easily removed during servicing/maintenance of the aftertreatment assembly 100 for accessing one or more components of the aftertreatment assembly 100. Further, the panel assembly 200 is easier to insulate and seal thereby reducing possibility of leakage of the exhaust gases. In an example, an inside of the panel assembly 200 that faces the aftertreatment system 102 is designed to allow mixing of the exhaust gases that are received within the outlet chamber 114. More particularly, the first and second openings 256, 258, 282 in the elongated members 204, 206 and the elongated intersecting members 208, 210, 212 include the air flow paths “F1”. The air flow paths “F1” allow movement of the exhaust gases therethrough. A movement of the exhaust gases through the air flow paths “F1” may further promote mixing of the exhaust gases. It should be noted that the first openings 256 and the second openings 282 facilitate mixing of the exhaust gases without significantly limiting the flow of exhaust gases along the panel member 202. As the panel assembly 200 promotes mixing of the exhaust gases, the baffle 122 and/or the second mixer tube 120 may include a simpler design or, in some instances, the baffle 122 and/or the second mixer tube 120 may be omitted. Further, the first openings 256 and the second openings 282 also provide guidance for the assembler/welder to weld the elongated members 204, 206 and the elongated intersecting members 208, 210, 212.

The panel assembly 200 is cost effective, easy to manufacture, and has a simple design. The panel assembly 200 described herein includes fewer part numbers as compared to conventional panel assemblies. Further, various parts of the panel assembly 200 such as the panel member 202, the elongated members 204, 206, and the elongated intersecting members 208, 210, 212 are light in weight thereby reducing an overall weight of the panel assembly 200.

Moreover, the elongated members 204, 206 and the elongated intersecting members 208, 210, 212 divide the panel member 202 into a number of areas 288 that may provide improved structural rigidity as compared to conventional panel assemblies. The lightweight members 204, 206, 208, 210, 212 may also eliminate localized pockets of vibrations by introducing damping effect into the panel assembly 200 thereby increasing a natural frequency of the panel assembly 200 to approximately between 200 hertz (Hz) and 230 Hz. The panel assembly 200 may minimize a system level drop in natural frequency and vibrations due to exhaust gas pressure pulsations. This phenomenon reduces a probability of failure of the panel assembly 200 due to pressure pulsations while the aftertreatment assembly 100 is in operation. Moreover, the design of the panel assembly 200 described herein may not require lab/field structural validation.

Further, the lifting eyes 232 of the panel member 202 help in removal of the panel member 202 from any direction. More particularly, irrespective of a mounting orientation of the aftertreatment system 102, the lifting eyes 232 may allow the panel assembly 200 to be lifted horizontally or vertically. Further, the lifting eyes 232 may allow removal of the panel assembly 200 even when the aftertreatment assembly 100 is in positioned in a compact space or at a location that is difficult to reach. Moreover, as the lifting eyes 232 are integral with the panel member 202, requirement of securing additional eyes to the panel member 202 may be eliminated. Further, the tap taper surfaces 252, 280 of the elongated and elongated intersecting members 204, 206, 208, 210, 212 may allow ease in manufacturing and assembly of the panel assembly 200. The taper surfaces 252, 280 of the elongated and elongated intersecting members 204, 206, 208, 210, 212 may also reduce stresses induced in the panel assembly 200. Moreover, the taper surfaces 252, 280 eliminates sharp corners thereby reducing safety concerns while manufacturing, assembly, and servicing of the panel assembly 200.

The elongated member 204 is welded to the panel member 202 at the corresponding outer surface 236 and the elongated member 206 is welded to the panel member 202 at the corresponding outer surface 236 which allows ease in accessibility and welding of the elongated members 204, 206. Further, the elongated intersecting members 208, 210, 212 are welded to the panel member 202 at the corresponding right surfaces 270 which allows ease in accessibility and welding of the elongated intersecting members 208, 210, 212. Moreover, welding the elongated members 204, 206 and the elongated intersecting members 208, 210, 212 only at the first and second base portions 246, 248, 274, respectively, reduces an amount of welding material used in the panel assembly 200, which in turn reduces weight and cost of the panel assembly 200 as well as weld distortion thereby providing a better quality product. Moreover, the first and second base portions 246, 248, 274 provide a self-locating feature that minimizes requirement of providing welding markings for welding of the elongated members 204, 206 and the elongated intersecting members 208, 210, 212 to the panel member 202.

Further, the welding of the elongated intersecting member 208, 210, 212 to the elongated members 204, 206 provides an inter-locking grid design. The first and second slots 260, 262 in the elongated members 204, 206 and the elongated intersecting members 208, 210, 212 provide a self-locating feature for securing the elongated intersecting members 208, 210, 212 to the elongated members 204, 206, thereby simplifying an assembly process of the panel assembly 200. Further, the weld marks 286 are vertically spaced apart from the weld marks 249, 276, thus the weld marks 286 do not interfere with the weld marks 249, 276.

It should be noted that dimensions of various parts of the panel assembly 200 may be varied based on the configurations/sizes of different aftertreatment assemblies, or other application requirements, thereby increasing versatility of the panel assembly 200. Further, the panel assembly 200 described herein can be associated with various configurations of aftertreatment systems.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof

What is claimed is:

1. A panel assembly comprising:
a panel member including a mounting side;
at least one elongated member including:
a mounting edge secured to the mounting side of the panel member;
a second edge opposite the mounting edge of the at least one elongated member and distal to the panel member; and
a plurality of first spaced apart openings proximate to the mounting edge of the at least one elongated member; and
at least one elongated intersecting member including:
a mounting edge secured to the mounting side of the panel member;
a second edge opposite the mounting edge of the at least one elongated intersecting member and distal to the panel member; and
a plurality of second spaced apart openings proximate to the mounting edge of the at least one elongated intersecting member;
wherein one of the at least one elongated member and the at least one elongated intersecting member includes at least one slot, the at least one elongated member and the at least one elongated intersecting member intersecting at the at least one slot.

2. The panel assembly of claim 1, wherein the at least one elongated member includes at least one first slot and the at least one elongated intersecting member includes at least one second slot, and wherein the at least one first slot intersects with the at least one second slot.

3. The panel assembly of claim 1, wherein each of the at least one elongated member includes a plurality of spaced apart first base portions such that each first base portion is disposed adjacent to a first opening, and wherein the at least one elongated member is secured to the panel member at the plurality of first base portions.

4. The panel assembly of claim 1, wherein each of the at least one elongated intersecting member includes a plurality of spaced apart second base portions such that each second base portion is disposed adjacent to a second opening, and wherein the at least one elongated intersecting member is secured to the panel member at the plurality of second base portions.

5. The panel assembly of claim 1, wherein the at least one elongated member and the at least one elongated intersecting member are secured to the panel member by welding.

6. The panel assembly of claim 1, wherein the at least one elongated intersecting member is secured to the at least one elongated member by welding.

7. The panel assembly of claim 1, wherein each of the plurality of first openings and the plurality of second openings is arch shaped.

8. The panel assembly of claim 1, wherein the panel member includes an outer periphery, a plurality of mounting apertures proximate to the outer periphery, and at least two lifting eyes extending from the outer periphery.

9. The panel assembly of claim 1, wherein the panel assembly is secured to a frame member of an aftertreatment system.

10. The panel assembly of claim 1, wherein each of the first openings and the second openings includes an air flow path.

11. The panel assembly of claim 1, wherein each of the first openings is disposed adjacent to the mounting edge of the at least one elongated member.

12. The panel assembly of claim 1, wherein each of the second openings is disposed adjacent to the mounting edge of the at least one intersecting member.

13. An aftertreatment assembly comprising:
an aftertreatment system including a frame member; and
a panel assembly secured to the frame member of the aftertreatment system, the panel assembly including:
a panel member including a mounting side;
at least one elongated member including:
a mounting edge secured to the mounting side of the panel member;
a second edge opposite the mounting edge of the at least one elongated member and distal to the panel member; and
a plurality of first spaced apart openings proximate to the mounting edge of the at least one elongated member; and
at least one elongated intersecting member including:
a mounting edge secured to the mounting side of the panel member;
a second edge opposite the mounting edge of the at least one elongated intersecting member and distal to the panel member; and
a plurality of second spaced apart openings proximate to the mounting edge of the at least one elongated intersecting member;
wherein one of the at least one elongated member and the at least one elongated intersecting member includes at least one slot, the at least one elongated member and the at least one elongated intersecting member intersecting at the at least one slot.

14. The aftertreatment assembly of claim 13, wherein the at least one elongated member includes at least one first slot and the at least one elongated intersecting member includes at least one second slot, and wherein the at least one first slot intersects with the at least one second slot.

15. The aftertreatment assembly of claim 13, wherein each of the at least one elongated member includes a plurality of spaced apart first base portions such that each first base portion is disposed between a pair of adjacent first openings, and wherein the at least one elongated member is secured to the panel member at the plurality of first base portions.

16. The aftertreatment assembly of claim 13, wherein each of the at least one elongated intersecting member includes a plurality of spaced apart second base portions such that each second base portion is disposed between a pair of adjacent second openings, and wherein the at least one elongated intersecting member is secured to the panel member at the plurality of second base portions.

17. The aftertreatment assembly of claim 13, wherein the panel member includes an outer periphery, a plurality of mounting apertures proximate to the outer periphery, and at least two lifting eyes extending from the outer periphery.

18. A method of assembling a panel assembly, the method comprising:
providing a panel member including a mounting side;
securing at least one elongated member to the panel member at the mounting side, wherein the at least one elongated member includes a mounting edge secured to the panel member, a second edge opposite the mounting edge of the at least one elongated member and distal to the panel member, and a plurality of first spaced apart openings proximate to the mounting edge of the at least one elongated member;
providing at least one elongated intersecting member includes a mounting edge, a second edge opposite the mounting edge of the at least one elongated intersecting member and distal to the panel member, and a plurality of second spaced apart openings proximate to the mounting edge of the at least one elongated intersecting member, wherein one of the at least one elongated member and the at least one elongated intersecting member includes at least one slot;
intersecting the at least one elongated member with the at least one elongated intersecting member at the at least one slot; and
securing the at least one elongated intersecting member to the panel member at the mounting side and the at least one elongated member at an intersection of the at least one elongated member and the at least one elongated intersecting member.

19. The method of claim 18, wherein the step of securing the at least one elongated member to the panel member includes welding the at least one elongated member to the panel member.

20. The method of claim 18, wherein the step of securing the at least one elongated intersecting member to the panel member and the at least one elongated member includes welding the at least one elongated intersecting member to the panel member and the at least one elongated member.
